(19) United States
(12) Patent Application Publication
(10) Pub. No.: US 2019/0251042 A1
(43) Pub. Date: Aug. 15, 2019

(54) MEMORY ACCESS CONTROL SYSTEM

(71) Applicant: STMicroelectronics (Rousset) SAS, Rousset (FR)

(72) Inventors: Dragos DAVIDESCU, Lambesc (FR); Olivier FERRAND, Aix-en-Provence (FR)

(73) Assignee: STMicroelectronics (Rousset) SAS, Rousset (FR)

(21) Appl. No.: 16/274,336

(22) Filed: Feb. 13, 2019

(30) Foreign Application Priority Data
Feb. 14, 2018 (FR) 1851252

(51) Int. Cl. G06F 12/14; G06F 9/48; G06F 9/38; G06F 13/28

(52) U.S. Cl. CPC G06F 12/1491; G06F 13/28; G06F 9/38; G06F 9/4806

(57) ABSTRACT

A memory access control system includes a first circuit supporting direct access to the memory and a second circuit that is associated with the first circuit and programmed to restrict an area of the memory that is accessible to the first circuit. A central processing unit operates in privileged mode to program the second circuit with a range of addresses within the memory where read and write operations are permitted and further operates in limited mode to program the first circuit with a starting address for read and write operations associated with the task to be executed. Starting execution of the task is performed if the starting address is within the range of addresses. The execution of the task is terminated if an address generated during execution falls outside the range of addresses.

### PRIORITY CLAIM

This application claims the priority benefit of French Application for Patent No. 1851252, filed on Feb. 14, 2018, the content of which is hereby incorporated by reference in its entirety to the maximum extent allowable by law.

### TECHNICAL FIELD

The present invention concerns the field of processors and, more particularly, the field of rights of access to memory areas according to the executed tasks.

### BACKGROUND

In the context of systems comprising a processor and a memory (for example, computers, phones, etc.), it is important to be capable of restricting the access to certain areas of the memory. It may, for example, be desired to restrict the access to confidential data or to system data.

This may, for example, be performed by including in the system a memory protection unit (MPU) associated with a central processing unit (CPU), for example, a processor. The MPU is capable of refusing access to memory areas to certain tasks carried out by the CPU. For example, an identifier and a memory area may be associated with certain tasks, and the access to this memory area may be denied to any task which does not have the associated identifier.

In such a system, the memory control is carried out by the MPU associated with the CPU. It is only possible to control the tasks one by one.

There is a need in the art to overcome all or part of the drawbacks of memory access control systems.

### SUMMARY

In an embodiment, a system for controlling the access to a memory comprises: at least one first circuit of direct access to the memory; and at least one second circuit, each second circuit being associated with a first circuit and being programmed to restrict the memory area accessible to said first circuit.

According to an embodiment, the system comprises a central processing unit capable of programming the second circuits.

According to an embodiment, the system comprises a memory protection unit having access to the addresses of the restricted access areas.

According to an embodiment, the system comprises at least eight first circuits.

Another embodiment provides a method of reading from or writing into a memory of a system such as that previously described.

According to an embodiment, when a task is started, the second circuit verifies, each time the destination address changes, whether the new address belongs to the memory area accessible to this task, and if it does not, the task is stopped.

According to an embodiment, the previous method comprises the steps of: a) assigning a first circuit to a task to be performed; b) programming the second circuit to define the memory area accessible during this task; c) programming the first circuit to define the memory address at which the task starts; and d) starting the task.

According to an embodiment, step b) is carried out in privileged mode.

According to an embodiment, step c) is carried out in a limited mode associated with the task.

According to an embodiment, steps b) and c) are carried out by a central processing unit.

According to an embodiment, steps a) to d) are repeated for each task to be carried out.

According to an embodiment, the tasks carried out by the at least one first circuit may be carried out in parallel.

### BRIEF DESCRIPTION OF THE DRAWINGS

The foregoing and other features and advantages will be discussed in detail in the following non-limiting description of specific embodiments in connection with the accompanying drawings, wherein:

FIG. 1 shows, in the form of blocks, an embodiment of a memory access control system;

FIG. 2 shows an implementation mode of an operating method of the system of FIG. 1;

FIG. 3 illustrates a step of the method of FIG. 2;

FIG. 4 illustrates another step of the method of FIG. 2;

FIG. 5 illustrates another step of the method of FIG. 2;

FIG. 6 illustrates another step of the method of FIG. 2;

FIG. 7 illustrates another step of the method of FIG. 2; and

FIG. 8 illustrates a step, not shown in FIG. 2.

### DETAILED DESCRIPTION

The same elements have been designated with the same reference numerals in the different drawings. For clarity, only those steps and elements which are useful to the understanding of the described embodiments have been shown and are detailed. In particular, the described systems comprise various other components which are not detailed.

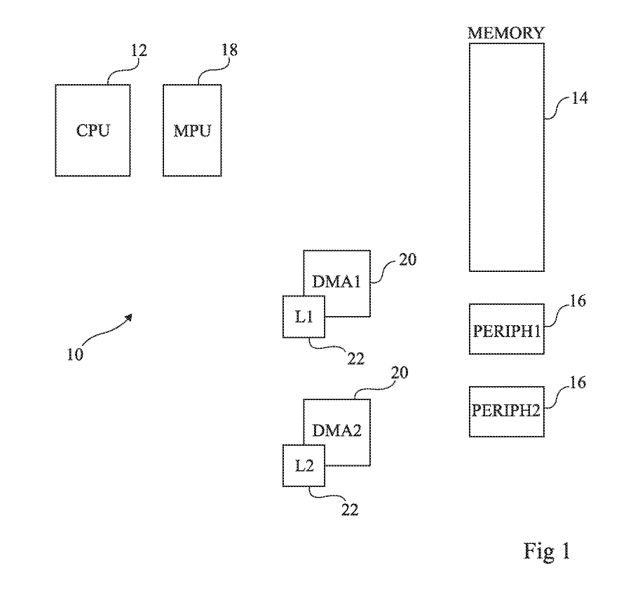

FIG. 1 shows, in the form of blocks, an embodiment of a memory access control system 10.

System 10 comprises a central processing unit (CPU) 12, a memory (MEMORY) 14, and a plurality of peripherals 16, two of which are shown (PERIPH1, PERIPH2). Peripherals 16 correspond to circuits capable of carrying out tasks, that is, of reading from or writing into memory 14. Peripherals 16 may be peripherals external to the system such as a printer or sensors connected to the system. Peripherals 16 may also be internal to the system, for example, other processors. The system further comprises a memory protection unit (MPU) 18 capable of denying or of accepting the access to certain areas of memory 14 for the CPU in certain usage modes other than a privileged mode, that is, a mode where the CPU has all authorizations and may access all the memory areas.

The system further comprises direct memory access circuits 20, two of which are shown (DMA1, DMA2). Preferably, there are, for example, at least eight DMA circuits, for example, between eight and sixteen DMA circuits. The DMA circuits correspond to channels through which data may be read or written by a peripheral 16 in memory 14 with no intervention of CPU 12 other than the starting of the reading or of the writing processes. A destination address of a DMA circuit corresponds to the address at which the reading or the writing by a peripheral is performed at a given time. This address may be programmed, for example, by the CPU, and changes along the writing or the reading.

According to an embodiment, each DMA circuit 20 is associated with a circuit (L1, L2) 22 of local protection of the memory. Each circuit 22 is capable of comparing the destination address of DMA circuit 20 with the addresses of the authorized memory areas of DMA circuit 20 each time the destination address changes, and thus of restricting the memory area accessible by the DMA circuit. Each circuit 22 is further capable of stopping the reading from or the writing into the memory if the address does not belong to the authorized areas. The memory area accessible by the DMA circuit may be programmed in circuit 22 by the CPU in privileged mode.

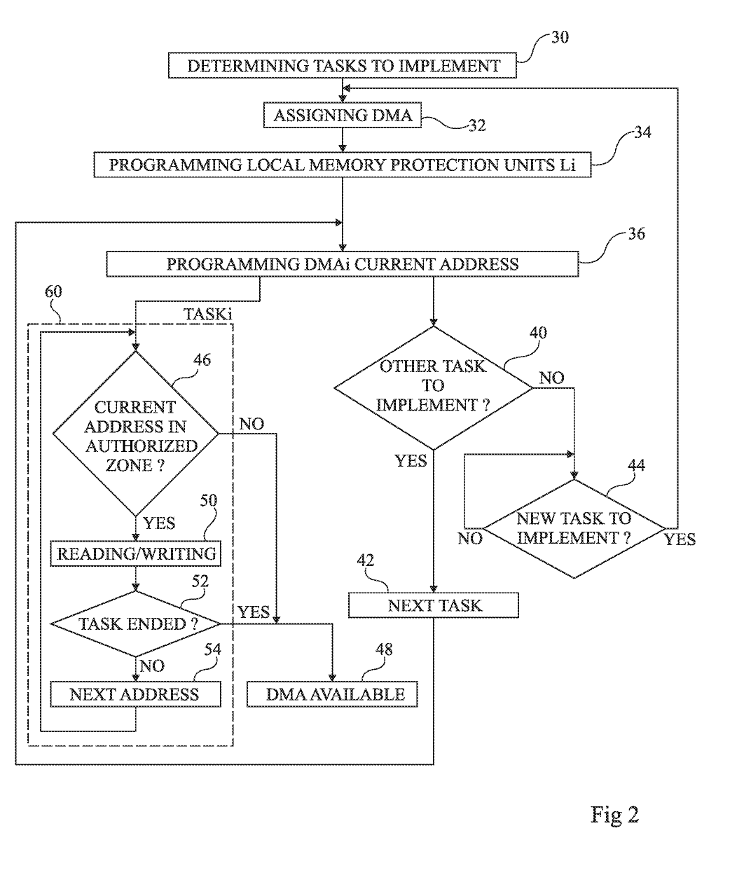

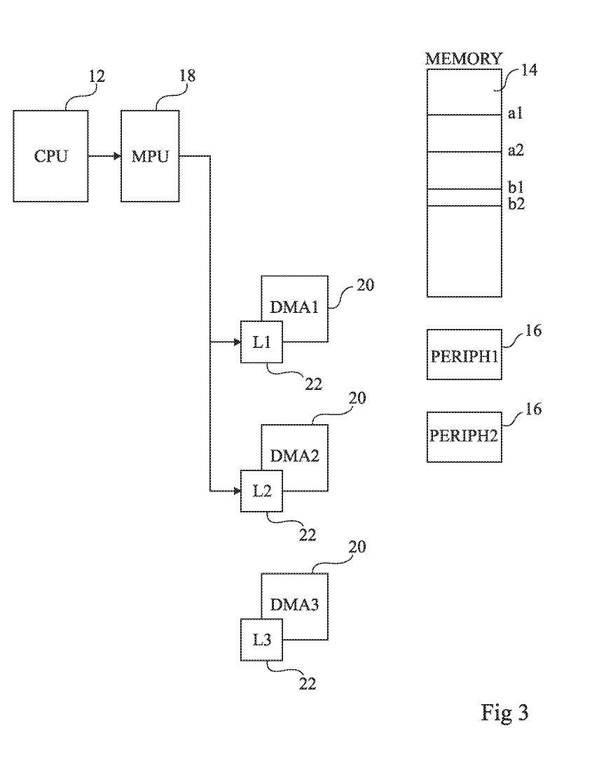

FIG. 2 shows an embodiment of a method of operation of the system of FIG. 1. Certain steps of the method of FIG. 2 are illustrated in FIGS. 3 to 8.

The CPU starts by determining, during a step 30 (DETERMINING TASKS TO IMPLEMENT), whether tasks originating from peripherals 16 can be executed by a DMA circuit. For simplification, index i is used hereafter to designate a DMA circuit, circuit 22, a task associated therewith, or a peripheral associated therewith, i being an integer in the range from 1 to N, N being the number of tasks capable of being executed by DMA circuits.

The CPU then executes a step 32 (ASSIGNING DMA) during which it assigns a DMA circuit to each task to be executed. If there are more tasks than DMA circuits, certain tasks are put to wait until a DMA circuit becomes available.

Step 32 is followed by a step 34 (PROGRAMMING LOCAL MEMORY PROTECTION UNITS Li) of programming the local memory protection units.

During step 34, the CPU switches to the privileged mode to program circuits 22. The programming of circuits 22 is only possible in privileged mode. The MPU has access to the addresses of the different memory areas authorized for each peripheral or for each task. The CPU uses, in privileged mode, the MPU and its data to program the circuits 22 associated with the DMA circuits to which a task has been assigned so that each circuit 22 authorizes the reading from and the writing into the authorized memory area associated with the corresponding task.

Step 34 is followed by a step 36 (PROGRAMMING DMAi CURRENT ADDRESS) during which the CPU leaves the privileged mode associated with a task i to which a circuit DMAi 20 has been assigned. The circuit 22 Li of this DMAi has been programmed. The MPU then ensures that the CPU access is restricted to the memory area associated with this task. During this step 36, the CPU programs the destination address of circuit DMAi as being the address at which the writing into or the reading from the memory should start for this task i. Such a programming causes the starting of task i (TASK i).

Once it has launched task i, the CPU determines (step 40—OTHER TASK TO IMPLEMENT?) whether another task to which a DMA circuit has been assigned should be performed.

If so (output YES of block 40), the CPU passes on to the next task (step 42—NEXT TASK) and returns at step 36 for this new task, that is, returns to the step of programming the destination address of the DMA circuit assigned to this other task.

If, at step 40, the CPU determines that all the tasks to which a DMA circuit has been assigned have been executed (output NO of block 40), the CPU determines (step 44—NEW TASK TO IMPLEMENT?) whether new tasks, to which no DMA circuit has been previously assigned, should be executed.

If not (output NO of block 44), memory access control system 10 is at standby until the arrival of a new task.

If one or a plurality of new tasks should be executed with a DMA circuit (output YES of block 44), it is returned to step 32 with the assignment of the DMA circuits to the different new tasks.

On the side of task i (block 60), circuit 22 of the DMA circuit starts by determining (step 46—CURRENT ADDRESS IN AUTHORIZED ZONE?), without using the CPU, whether the destination address is in the authorized area, for example, by comparing it with the limits of an address range programmed at step 34.

If it is not (output NO of block 46), the task is considered as ended and the DMA circuit is available again to be assigned to another task (step 48—DMA AVAILABLE).

If it is (output YES of block 46), the peripheral PERIPHi of the task reads from or writes into the memory line at the destination address (step 50—READING/WRITING).

Peripheral PERIPHi then determines whether the task is ended (step 52—TASK ENDED?). If it is (output YES of block 52), the DMA circuit is available again to be assigned to another task (step 48). If it is not (output NO of block 52), the destination address of the DMA circuit is changed to become the next address (step 54—NEXT ADDRESS) and it is returned to step 46.

Steps 46 to 54, corresponding to the actual execution of the task, are carried out in parallel, for each task to which a DMA circuit has been assigned, after the programming by the CPU of the destination address.

FIGS. 3 to 8 illustrate an example of application of the steps of the method of FIG. 2 in the case of system 10 of FIG. 1. In this example, it is considered that the two peripherals 16, PERIPH1 and PERIPH2, attempt to access memory 14 over DMA circuits. Circuits DMA1 and DMA2 have been respectively assigned to task 1 of peripheral PERIPH1 and to task 2 of peripheral PERIPH2.

FIG. 3 illustrates step 34, during which the CPU passes to the privileged mode to program the circuits 22 of circuits DMA1 and DMA2.

CPU 12 uses, in privileged mode, MPU 18 to program circuit L1 associated with circuit DMA1, so that it restricts the reading and the writing by peripheral PERIPH1 to the memory area comprised between addresses a1 and a2. Similarly, the CPU programs circuit L2, associated with circuit DMA2, so that it restricts the reading and the writing by peripheral PERIPH2 to the memory area comprised between addresses b1 and b2.

The system also comprises, in this example, a circuit DMA3 which is not assigned to a task, its circuit 22 L3 being thus not programmed by the CPU at this step.

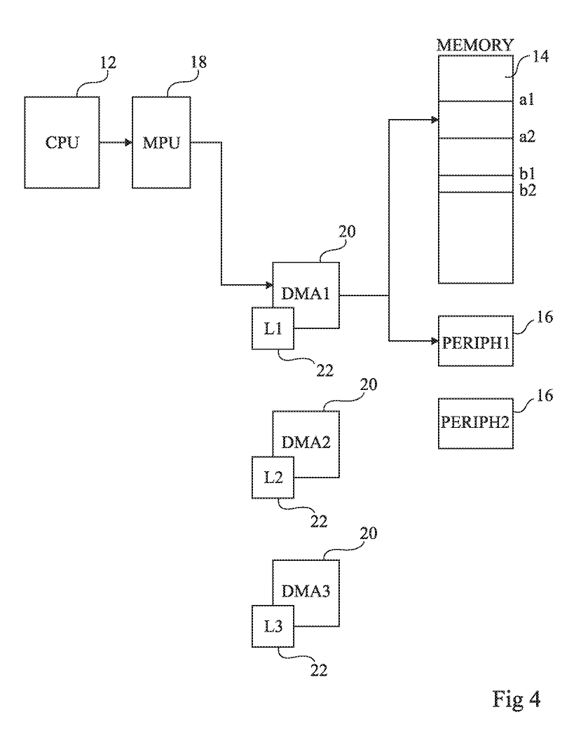

FIG. 4 illustrates steps 36 and 46, for the task 1 associated with peripheral PERIPH1.

During step 36, the CPU leaves the privileged mode and enters a limited mode associated with task 1. The MPU then ensures that the access of the CPU is restricted to the area of the memory associated with this task 1 (addresses a1 to a2). The CPU then programs the destination address of circuit DMA1 to be the address at which the writing into or the reading from the memory should start. During step 46, circuit L1 compares this address to the authorized areas and authorizes or not the beginning of the task, that is, the reading from or the writing into the memory (step 50). In parallel with the execution of task 1, the CPU determines (step 42) that a DMA circuit has been assigned to another task, for example, task 2, associated with peripheral PERIPH2.

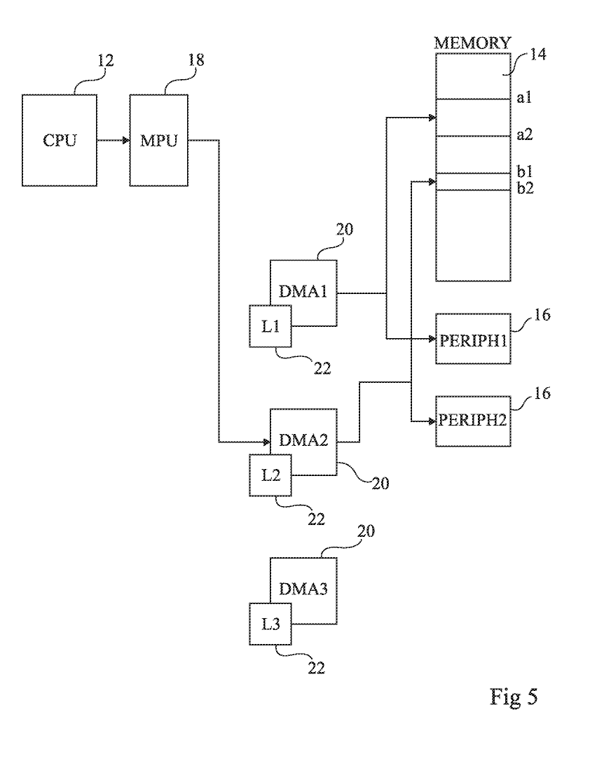

FIG. 5 illustrates steps 36 and 46, for task 2.

During step 36, the CPU enters a limited mode, associated with task 2. In the same way as previously, the access of the CPU is restricted to the area (addresses b1 to b2) of the memory associated with this task. The CPU then programs the destination address of circuit DMA2 to be the address at which the writing into or the reading from the memory should start. During step 46, circuit L2 compares this address with the authorized areas and authorizes or not the beginning of task 2.

Task 1 of peripheral PERIPH1 may be finished, in which case circuit DMA1 is made available (step 48) to be assigned to a new task. If not, task 1 of peripheral PERIPH1 carries on, that is, steps 46, 50, 52, and 54 are repeated. Indeed, the presence of circuit DMA1 enables a reading or a writing without the use of the CPU, which is then busy programming circuit DMA2.

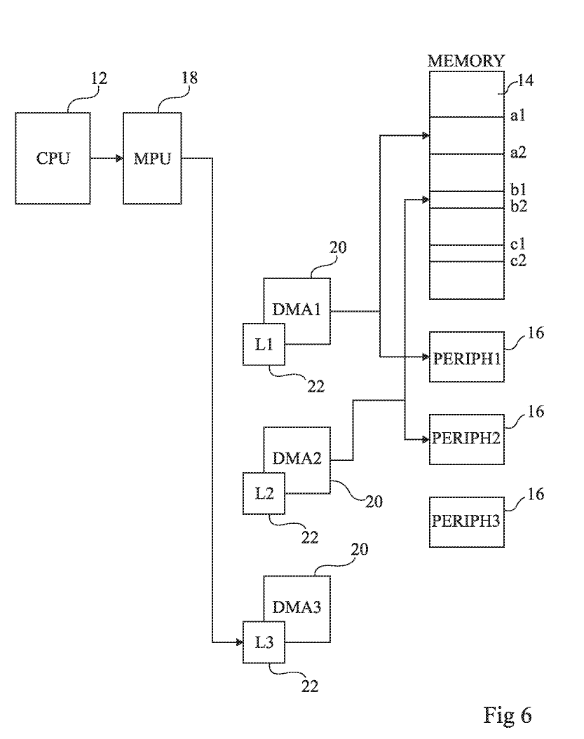

FIG. 6 illustrates steps 32 and 34 of application of the method of FIG. 2.

In parallel with the execution of tasks 1 and 2 associated with peripherals PERIPH1 and PERIPH2, another peripheral 16 (PERIPH3) attempts to perform a task 3 with a DMA circuit, which is determined by the CPU at step 44 following the programming of circuit DMA2.

The method is thus resumed at step 32 during which the CPU enters the privileged mode to assign a DMA circuit, here, circuit DMA3, to task 3. The CPU then programs circuit L3 (step 34) to restrict the access to circuit DMA3 to addresses in the range from c1 and c2.

Tasks 1 and 2 performed by peripherals PERIPH1 and PERIPH2 may be still going on or may be ended.

If there is no further available DMA circuit when a new task attempts to access the memory through a DMA circuit, the task is for example put to wait. A priority system may also be established, where a task having a lower priority level may be put to wait to assign the DMA circuit to another task. The task having the lowest priority level is resumed at the end of the task holding the priority.

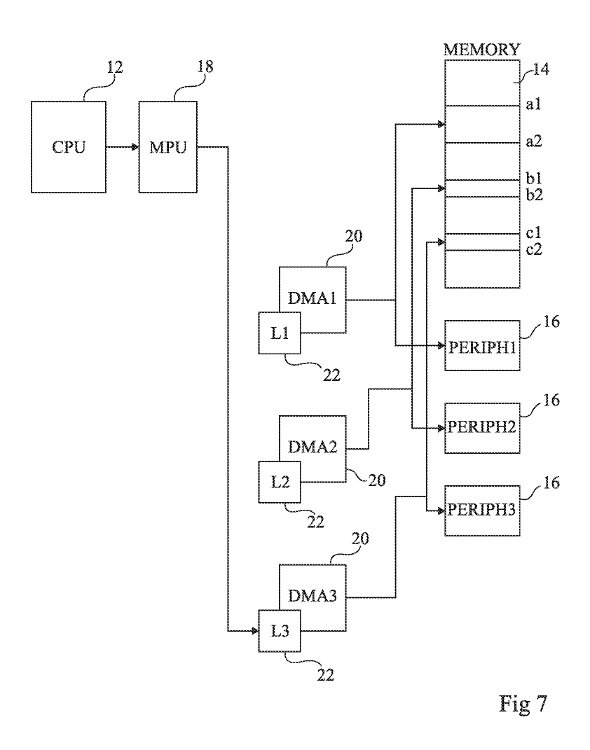

FIG. 7 illustrates steps 36 and 46, for the task 3 associated with peripheral PERIPH3, during which the CPU enters a limited mode associated with task 3 of peripheral PERIPH3. As previously, the CPU only has access to the area (addresses c1 to c2) of the memory associated with task 3. The CPU then programs circuit DMA3 (step 36) to define the destination address of circuit DMA3 to be the address at which the writing into or the reading from the memory should start. Circuit L3 compares this destination address with the authorized areas and authorizes or not the beginning of task 3 (step 46).

Tasks 1 and 2 of peripherals PERIPH1 and PERIPH2 may be still going on or may be ended.

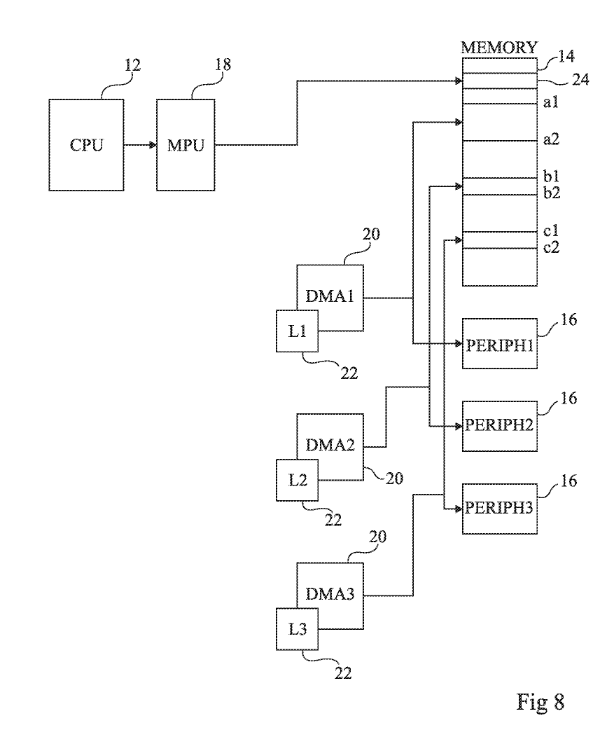

FIG. 8 illustrates a step, not shown in FIG. 2, during which a task which is not programmed to be carried out by a DMA circuit is directly carried out by the CPU. To achieve this, the CPU enters a limited mode where it has access to none of the assigned and protected areas of the memory, the addresses of which are known by the MPU. This task may be carried out after the tasks have been started or between two tasks, for example, according to the priority level.

The CPU then reads from or writes into an area 24 of the memory and the MPU ensures that the CPU accesses no protected area.

During this step, the tasks performed by DMA circuits carry on independently from the CPU.

An advantage of the described embodiments it that it is impossible for a task, for example, originating from a malware, to reach protected memory areas, even if this task is executed by a DMA circuit and is thus not controlled by the MPU.

Specific embodiments have been described. Various alterations, modifications, and improvements will occur to those skilled in the art. In particular, the area associated with each DMA circuit and programmed in the corresponding circuit of local protection of memory 22 is not limited to a single continuous area but may for example correspond to a plurality of different areas.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A system for controlling access to a memory, comprising:
a first direct memory access circuit configured to support direct access to the memory;
a first protection circuit that is associated with the first direct memory access circuit, said first protection circuit being programmable to restrict an area of the memory which is accessible to said first direct memory access circuit for read and write operations;
a second direct memory access circuit configured to support direct access to the memory;
a second protection circuit that is associated with the second direct memory access circuit, said second protection circuit being programmable to restrict an area of the memory which is accessible to said second direct memory access circuit for read and write operations;
a central processing unit configured to:
operate, in privileged mode, to program each of the first and second protection circuits with a range of addresses within the memory where read and write operations are permitted;
operate, in a limited mode, to program the first direct memory access circuit with a first starting address for read and write operations associated with a first task to be executed; and
operate, in the limited mode, to program the second direct memory access circuit with a second starting address for read and write operations associated with a second task to be executed;
said first protection circuit operating to authorize beginning execution of the first task only if the first starting address is within the range of addresses programmed in the first protection circuit; and
said second protection circuit operating to authorize beginning execution of the second task only if the second starting address is within the range of addresses programmed in the second protection circuit.

2. The system of claim 1, further comprising a memory protection circuit, wherein the central processing unit operations to program the first and second protection circuits and the first second direct memory access circuits are performed through the memory protection circuit.

3. The system of claim 2, wherein the memory protection circuit operates to block accesses to certain areas of the memory by the central processing unit except when the central processing unit is in privileged mode.

4. The system of claim 1, wherein the central processing unit, when operating in privileged mode, has authorization to access all memory areas, and wherein the central processing unit, when operating in limited mode, has access to only an area of the memory within the programmed range of addresses.

5. The system of claim 1, wherein, following beginning execution, the first and second tasks are executed in parallel without participation by the central processing unit.

6. The system of claim 1, wherein:
the first protection circuit is configured to terminate execution of the first task if the first task requests access to the memory with an address that is outside of the range of addresses programmed in the first protection circuit; and
the second protection circuit is configured to terminate execution of the second task if the second task requests access to the memory with an address that is outside of the range of addresses programmed in the second protection circuit.

7. A method for controlling access to a memory with a system including a first direct memory access circuit configured to support direct access to the memory, a first protection circuit associated with the first direct memory access circuit, a second direct memory access circuit configured to support direct access to the memory and a second protection circuit that is associated with the second direct memory access circuit, the method comprising:
programming, by a central processing unit configured to operate in a privileged mode, of each of the first and second protection circuits with a range of addresses, wherein each range of addresses defines a restricted area of the memory which is accessible to said first direct memory access circuit for read and write operations;
programming, by a central processing unit configured to operate in a limited mode, of the first direct memory access circuit with a first starting address for read and write operations associated with a first task to be executed;
programming, by the central processing unit configured to operate in the limited mode, of the second direct memory access circuit with a second starting address for read and write operations associated with a second task to be executed;
authorizing by said first protection circuit beginning execution of the first task only if the first starting address is within the range of addresses programmed in the first protection circuit; and
authorizing by said second protection circuit beginning execution of the second task only if the second starting address is within the range of addresses programmed in the second protection circuit.

8. The method of claim 7, further comprising programming the first and second protection circuits and the first second direct memory access circuits by the central processing unit through a memory protection circuit.

9. The method of claim 8, further comprising blocking, by the memory protection circuit, of access to certain areas of the memory by the central processing unit except when the central processing unit is in privileged mode.

10. The method of claim 7, further comprising granting the central processing unit authorization to access all memory areas when operating in privileged mode, and granting the central processing unit access to only an area of the memory within the programmed range of addresses when operating in limited mode.

11. The method of claim 7, further comprising, following beginning execution, executing the first and second tasks in parallel without participation by the central processing unit.

12. The method of claim 7, further comprising:
terminating execution of the first task by the first protection circuit if the first task requests access to the memory with an address that is outside of the range of addresses programmed in the first protection circuit; and
terminating execution of the second task by the second protection circuit if the second task requests access to the memory with an address that is outside of the range of addresses programmed in the second protection circuit.

13. A method of reading from or writing into a memory of a system for controlling the access to a memory, said system comprising at least one first circuit supporting direct access to the memory, and at least one second circuit associated with each first circuit, the method comprising:
a) assigning a task to be carried out to the first circuit;
b) programming the second circuit to restrict an area of the memory which is accessible to said first circuit, wherein step b) is carried out in privileged mode;
c) programming the first circuit to define the address of the memory at which the task starts, wherein step c) is carried out in a limited mode associated with the task;
d) determining whether the address is within the restricted area and if so then starting execution of the task;
e) monitoring addresses during execution of the task; and
f) terminating the test if any of the monitored addresses is outside the restricted area.

14. The method of claim 13, wherein steps b) and c) are carried out by a central processing unit.

15. The method of claim 13, wherein steps a) to f) are repeated for each task to be carried out.

16. The method of claim 13, wherein plural tasks are assigned to different first circuits and the plural tasks are carried out in parallel.
